(19) United States
(12) Patent Application Publication
(10) Pub. No.: US 2021/0089988 A1
(43) Pub. Date: Mar. 25, 2021

(54) ALLOCATION AND RELOCATION IN VEHICLE OR RIDE-SHARING SYSTEMS BY TRAINING OF AN OBJECTIVE FUNCTION

(71) Applicant: Mobility-Science Inc., Sunrise, FL (US)

(72) Inventors: Kevin TIERNEY, Bielefeld (DE); Frederik SCHULTE, Rotterdam (NL)

(73) Assignee: Mobility-Science Inc., Sunrise, FL (US)

(21) Appl. No.: 17/009,997

(22) Filed: Sep. 2, 2020

(30) Foreign Application Priority Data
Sep. 23, 2019 (DE) 202019105258.9

(51) Int. Cl. G06Q 10/06; G06Q 30/06; G06N 20/00

(52) U.S. Cl. CPC G06Q 10/06315; G06N 20/00; G06Q 30/0645

(57) ABSTRACT

A system, a software, and a method of generating a model regarding the allocation and relocation problem in vehicle-sharing or ride-sharing systems, especially free-floating vehicle-sharing systems. The system, software, and method are suitable for a large number of locations or a large area and/or a large number of vehicles, and especially considering potential future demands, while improving modeling of the demand. The area or location is an area or location on the earth. The method includes an iterative method, especially an iterative computer-implemented method, for generating a model for forecasting vehicle demand and/or allocation and/or reallocation of vehicles based on this model in a free-floating vehicle sharing (FFVS) system. The disclosure further concerns methods for positioning vehicles for rent, forecasting suitable positions for (re-)positioning of vehicles for rent and/or forecasting vehicle demand using said model.

### TECHNICAL FIELD

The invention concerns an iterative method, especially an iterative computer-implemented method, for generating a model for forecasting vehicle demand and/or allocation and/or reallocation of vehicles based on this model in a free-floating vehicle sharing (FFVS) system. The invention further concerns methods for positioning vehicles for rent, forecasting suitable positions for (re-)positioning of vehicles for rent and/or forecasting vehicle demand using said model and a method for generating such model using said iterative method.

### BACKGROUND

### Background Information

The concept of free-floating vehicle sharing (FFVS) is a current topic. Since space, particularly parking space, is sparse in crowded cities having crowded streets, many people prefer public transportation instead of using privately-owned vehicles. Furthermore, especially in big cities, a significant part of the people do not own their own vehicle or car for various reasons including that such vehicles are quite expensive to purchase and operate, and because public transport is a more suitable alternative from both a cost point of view and an environmental point of view. Nevertheless, people who do not own their own vehicle may still need a vehicle from time to time. Therefore, the concept of vehicle-sharing has risen in popularity in the past decade as an, especially cheaper, alternative to taxis or other transport services.

As a consequence, a wide variety of shared mobility concepts have been proposed in the prior art. For example, Alonso-Mora et al. (US 2018/0231984 A1, US 2018/0224866 A1) describe a concept for ride-hailing or ride-sharing systems. The main task asserted to be solved is a combined assignment and routing problem incorporating a prediction of future demands for rides based on historical data being used as input for the assignment and routing model. Furthermore, rebalancing movements are an implicit result of solving linear programs for the combined assignment and routing problem. In ride-hailing systems, e.g. within the model of Alonso-Mora et al., decisions to assign a user request or user demand to a vehicle or ride define satisfied demands, while a driver or vehicle, e.g. a taxi or another user, will be moved to the location of the request as a result of such a decision. Moreover, the raid-hailing is focused on cost-efficient user/demand assignment and routing decisions, while explicit relocation decisions of vehicles is not included in the concept of Alonso-Mora et al. Hence, it is neither needed to consider specified regions or areas nor needed to use such regions or areas as a part of the Alonso-Mora et al. decision model.

However, relocation problems are known in the state of the art. Schmid et al. (Schmid et al., Solving the dynamic ambulance relocation and dispatching problem using approximate dynamic programming, Eur. J. Oper. Res., 219 (2012), pp. 611-621) depicts a concept for dynamic ambulance relocation and dispatching, where the main target is to minimize the travel time of an ambulance to emergency patients in order to serve emergency requests as fast as possible. In case of an emergency request an appropriate vehicle needs to be sent immediately to the request site and afterwards needs to be relocated to a waiting location, therefore, approximate dynamic programming is used in this system. Empirical tests in Vienna showed a decrease of an average response time between an emergency request and an ambulance reaching the request site by approximately 13% compared to previously known dispatching or relocation strategies.

Another concept applying approximate dynamic programming for ambulance redeployment is presented by Maxwell et al. (Maxwell et al., Approximate Dynamic Programming for Ambulance Redeployment, Informs J. Comput., Vol. 22, No. 2, 2010, pp. 261-281). This system uses simulated cost trajectories to tune the parameters in a value function.

Godfrey et al. (Godfrey et al., An Adaptive Dynamic Programming Algorithm for Dynamic Fleet Management, I: Single Period Travel Times, Transport Sci., Vol. 36, No. 1, 2002, pp. 21-39) present an adaptive programming algorithm for dynamic fleet management in order to address a stochastic dynamic resource allocation problem which is present in various settings, e.g., fleet management or assignment of vehicles in vehicle rental fleets. The main task of this system is to determine which and how many vehicles have to be moved empty between settled locations as well as which type of vehicles and/or how many of such should be assigned to a particular vehicle pool. Godfrey et al. use a concave adaptive value estimation to address the stochastic dynamic resource allocation problem. Instead of non-linear approximations, Godfrey et al. use piecewise-linear approximations of the value functions constructed by the concave adaptive value estimation in the adaptive dynamic programming algorithm in order to minimize repositioning costs based on a two-stage network problem approach. However, due to the two-stage network approach, this method is only suitable for less than 80 locations and/or 400 vehicles. Thus, the method is not sufficient to solve relocation problems in large cities.

Simão et al. describe approximate dynamic programming to be applicable for models that simulate movements of drivers in truckload transport and logistics (Simão et al., An Approximate Dynamic Programming Algorithm for Large-Scale Fleet Management: A Case Application., Transport Sci., Vol. 43, No. 2, 2009, pp. 178-197).

Information regarding the mathematical methods or algorithms mentioned above can be found in a review article of Powell et al. (Powell et al., Approximate dynamic programming in transportation and logistics: a unified framework, EURO J. Transp. Logist., Vol. 1, Issue 3, 2012, pp. 237-284).

### SUMMARY

An object of the present invention is to provide a solution to the allocation and relocation problem in vehicle-sharing or ride-sharing systems, especially free-floating vehicle-sharing systems, where the solution is suitable for a large number of locations or a large area and/or a large number of vehicles, and especially considering potential future demands, while improving modeling of the demand. The area or location may be an area or location on the earth.

The object is accomplished by an iterative method, especially a computer-implemented method, to generate a model to calculate:
at least one marginal value of a vehicle of a set of vehicles at a geographic location and/or an area within a given set of geographic locations or geographic areas and/or
at least one marginal value of an allocation of one of said vehicles of said set of vehicles to at least one demand of a set of vehicle demands and/or
at least one marginal value of relocation of a vehicle of said set of vehicles to a geographic repositioning location or geographic repositioning area within a given set of geographic locations or geographic areas
   generated by generating a value function approximation (VFA). This VFA might be found by Algorithm 1 which returns such VFA in line 19. For a vehicle-sharing system or ride-sharing system, especially for a free-floating vehicle sharing (FFVS) system with a set of vehicles for rent, said value function approximation (VFA) provides,
at least one marginal value of a vehicle of said set of vehicles at a geographic location and/or
at least one marginal value of an allocation of one of said vehicles of said set of vehicles to at least one demand of a set of vehicle demands and/or
at least one marginal value of relocation of a vehicle of said set of vehicles to a geographic repositioning location or geographic repositioning area.

Said value function approximation (VFA) is therefore
a) initialized e.g. by lines 1 to 4 of Algorithm 1 and
b) updated by iterating over at least two scenarios of demands and vehicle allocations each over at least two periods of time and for at least some, especially each, of said periods of time (e.g. as shown in lines 5 to 18 of Algorithm 1),
   i. calculating a set of vehicle locations or areas, especially a preferable set of vehicle locations or areas, or a subset of said given set of vehicle locations or areas by use of the current value function approximation (VFA) (e.g. linen 8 to 10 of Algorithm 1), and
   ii. updating the value function approximation (VFA) by using numerical derivatives of the current value function approximation (VFA) at the vehicle locations of or a subset of the vehicle locations of the, especially preferable, set of vehicle locations or areas determined in current step b.i, e.g. by lines 16 and 17 of Algorithm 1.

By calculating marginal values for vehicles being at a certain location and/or allocation and/or relocation of vehicles using the VFA derived by the iterative method as described above, the value of vehicles at certain locations or being allocated or relocated is determined giving a suitable base for allocation and/or relocation decisions provided by the generated value function approximation (VFA).

Calculating marginal values by a VFA generated by described iterative method leads to suitable information whether the demand for vehicles in a certain location or area exceeds or deceeds the vehicle capacity at that certain location or area (at a given time). It is therefore possible to determine whether vehicles stay unallocated at a certain location or area as well as whether an additional vehicle has to be moved to a certain area to satisfy, especially all, vehicle demands at a certain location or area (at a given time). Thus, costs of relocation and additional gain due to a probable allocation of a vehicle at another location or area are considered with respect to each other helping to maximize yields in the free-floating vehicle sharing system, while the iterative method also ensures maximizing the number of demands being fulfilled. It is furthermore possible to calculate by the VFA whether an additional vehicle in the system is beneficial.

In an advantageous embodiment, the updating in step b.ii includes or is performed by adding a term including a numerical right or left derivative to the current VFA and adding a term including a numerical right or left derivative to the previous VFA, especially by adding a term including the difference between a numerical right or left derivative to the current VFA and a numerical right or left derivative to the previous VFA, multiplied by a learning rate factor (cf. lines 16 and 17 in Algorithm 1).

Advantageously, the model and/or the iteratively updated value function approximation (VFA) is used to calculate repositioning decisions and/or allocation of vehicles to vehicle demands. Furthermore, the model and/or the iteratively updated value function approximation (VFA) advantageously is used to allocate vehicles to demands and/or reposition vehicles on earth according to the calculation.

In an advantageous embodiment, the value function approximation is piecewise linear (cf. line 3 in Algorithm 1). In contrast to non-linear functions, piecewise linear functions for the same problem are able to be solved significantly faster.

Advantageously, the number of pieces in said piecewise-linear function equals the number of vehicles that, on average, generate marginal value. Additionally or alternatively, the values of the pieces in said piecewise-linear function represent the marginal value of a respective number of vehicles in a location, which is a scenario- and/or time-dependent value that is iteratively updated.

In another advantageous embodiment, initialization includes calculating the number of vehicles that, on average, generate additional value in the first number of scenarios of vehicle demands (cf. Algorithm 2 and line 3 of Algorithm 1). Additionally, said piecewise-linear value function approximation (VFA) with as many pieces as the number of vehicles that, on average, generate additional value in the first number of scenarios of demands is used. In particular, the value function approximation (VFA) is initialized in such a way that the values of the pieces represent the average marginal value of a respective number of vehicles in a location or area.

A set or subset of vehicle locations is used to reduce the calculation effort. Choosing the set or subset and/or changing the set or subset improves the results and/or enables a reduction in locations and thereby a reduction in calculation efforts.

Advantageously, the, especially preferable, set of vehicle locations in step b.ii is calculated by solving a mixed-integer program and/or the set is a near-optimal set regarding the value. Said sets of vehicle locations can be heuristic solutions and therefore, calculation time, effort and/or costs can be lowered.

In another advantageous embodiment, different subsets of said set of vehicles are used in different iterations optimizing the selected, especially flexible, locations during iteration through times and/or scenarios. This enables calculation time, effort and/or costs to be further lowered.

In another advantageous embodiment, an initial set of geographic locations or areas is selected from said given set of geographic locations or areas prior to initializing said value function approximation (VFA). This is particularly accomplished by computing a heuristic score that indicates whether demand deceeds or exceeds the number of vehicles in the subset of vehicles at a location or in an area or within a predefined radius around a location. This is further accomplished by choosing, as a first initial set, all or a subset of locations or areas that exceed or deceed the mean demand by a predefined threshold. Preferably for each of the multitude of locations and/or areas, a piece of said piecewise-linear function is calculated to initialize said value function approximation (VFA). Thus, it can be ensured that the starting parameters for vehicles and/or locations or areas and/or subsets of vehicles and/or locations or areas are improved prior to the initialization and updating process, so that the amount of iterations within the updating process is able to be decreased because of the improved starting parameters.

In an especially advantageous embodiment, in at least every 5th iteration prior to next step b.i or at least once within or after iterating through the periods of time of a scenario prior to next step b.i, a subset of said given set of locations or areas is chosen (e.g. by Algorithm 4), especially by
i. evaluating a set of potential new locations or areas of said given set of locations or areas, especially those within a predefined distance to members of the subset,
ii. after applying the current value function approximation (VFA), updated during the previous iteration to the demands of the current period of time, choosing a subset by selecting from said set of potential new locations or areas those with maximal demand, especially including both fulfilled and unfulfilled demands, for vehicles and/or those with maximal unallocated vehicles in the previous period, especially if at least two locations or areas of said potential new locations or areas show the same amount of demand the location(s) or area(s). The lowest amount of unallocated vehicles of said at least two locations or areas is/are selected for said chosen subset.

Accordingly, chosen subsets of said given set of locations or areas may be optimized in such a way that best suited locations or areas are identified. This enables maximizing the use of such locations for calculating the VFA. Choosing such locations dynamically allows for maximizing such use for non-static demands and vehicle locations. This is the case, for example, when comparing morning rush hour to afternoon rush hour. The method maximizes the accuracy of calculation by use of minimal calculation efforts.

Advantageously, all locations or areas are of identical size and/or identical shape.

In another advantageous embodiment (cf. line 10 of Algorithm 1), the value function approximation (VFA) is a concave piecewise-linear separable VFA and/or a piecewise-linear separable VFA with fixed integer breakpoints, e.g., defined by:

V̅ₜ(Rₜ)=Σ_{i∈L}V̅ᵢₜ(Rᵢₜ) (0)

Advantageously, the value function approximation or objective function (1) to be maximized is an adapted Bellman function summing the cost of repositioning Σ_{i∈L} Σ_{j∈L} cᵢⱼ^{r}xᵢⱼ with the profit from satisfying demands and the (future) value of placing vehicles at each location:

Vₜ(Rₜ)=max−Σi∈LΣ_{j∈L}cᵢⱼ^{r}xᵢⱼ+1/|Ω|Σ_{i∈L}Σ_{ω∈Ω}(wᵢ(ω)+zᵢ(ω)) (1)

Furthermore, updating in step b.ii takes into account one or more of the following constrains, advantageously:
flow conservation due to every vehicle being repositioned, assigned to a demand or left idle at a current period of time, ensuring that the number of vehicles repositioned and demands satisfied does not exceed the number of vehicles available in any scenario, e.g., defined by:

Σ_{j∈L}(xᵢⱼ+yᵢⱼ^{s}(ω))+yᵢ^{D}(ω)≤Rᵢₜ∀i∈L,w∈Ω (2)
and/or
keeping track of vehicle movements enabling decisions at a subsequent period of time considering the repositioning decisions and the destinations of satisfied demands at the current period of time and that a single demand can only be assigned once, and/or
considering that vehicles are moved due to meet demands within a single period, thus taking into account exogenous effects of customers, e.g. by

zᵢ(ω)≤eᵢₛ(Rᵢₜ)+Σ_{j∈L}(xⱼᵢ+yⱼᵢ^{s}(ω)−xᵢⱼ−yᵢⱼ^{s}(ω))−yᵢ^{D}(ω))+fᵢₛ∀i∈L,ω∈Ω,s∈S (3)
and/or
limiting the amount of outgoing demand from a particular location within a single period, e.g. by

yᵢⱼ^{s}(ω)≤\hat{D}ᵢⱼ^{s}(ω)∀i∈L,ω∈Ω (4)
and/or
by determining the piecewise function for demand revenue for each scenario, e.g. by

wᵢ(ω)≤gᵢₛ(ω)(Σ_{j∈L}yᵢⱼ^{S}(ω)+yᵢ^{D}(ω))+hᵢₛ(ω)∀i∈L,ω∈Ω,s∈S (5)
and/or
ensuring non-negativity of the decision variables., e.g. by

xᵢⱼ≥0∀i,j∈L (6)

Additionally to the inventive iterative method, the object is accomplished by
a method for positioning vehicles for rent,
a method for providing free-floating vehicles for rent,
a method for providing suitable positions for positioning or repositioning of vehicles for rent,
a method for forecasting vehicle demand and/or
a method for providing a model to forecast vehicle demand and/or calculate suitable positions for (re-)positioning of vehicles for rent
   using a model generated by an iterative method as described above.

For the purpose of the methods described above, current positions of said vehicles for rent should be trackable in real-time, e.g. via a Global Positioning System (GPS). Alternatively, such positions may be entered and updated by users and/or personnel. Thus, said vehicles may have a GPS-tracking device. Apprehended positional data may then be sent to and received by a processing system containing a data storage device as well as a processing unit. The processing unit may be a central processing unit (CPU). Received data may be used to keep track of the vehicle positions and may be used in said iterative method performed by said processing unit to update or generate said model, said model being used for positioning the vehicles for rent, for providing free-floating vehicles for rent, providing suitable positions for positioning or repositioning of vehicles for rent, for forecasting vehicle demand and/or for providing said model to forecast vehicle demand and/or calculate suitable positions for (re-)positioning of vehicles for rent. Furthermore, the processing system may have a communication unit to communicate the achieved model to an analyzation unit which derives allocation decisions and/or reposition decisions based on the communicated achieved model. Alternatively, the processing system may analyze the achieved model itself, hence communicating allocation decisions and/or reposition decisions via the communication unit, e.g. such that an allocation of a vehicle to a demand is communicated to a user seeking for a vehicle for rent, or that a vehicle is repositioned, in particular by personnel of a vehicle rental company handling the relocations, or e.g. in case of autonomous driving, a vehicle repositions itself to a communicated geographical location or geographical area based on the communicated reposition decision or the communicated achieved model.

Following vehicle specification and processing system specification may be applied as well to the, especially computer-implemented, iterative method as described above. For instance, the present disclosure may provide a system comprising a processing unit comprising one or more processors; memory coupled with and readable by the processing unit and storing therein a set of computer-readable instructions; wherein the set of computer-readable instructions, when executed by the processing unit, causes the processing unit to calculate or update a VFA as described above.

In another aspect, the present disclosure may provide a system comprising a processing unit comprising one or more processors; memory coupled with and readable by the processing unit and storing therein a set of computer-readable instructions; and a communication interface or communication engine; wherein the set of computer-readable instructions, when executed by the processing unit, causes the processing unit to calculate marginal values of vehicles at a geographic location and/or area, of an allocation of vehicles to demands and/or of relocation of vehicles to a geographic repositioning location or area by generating a value function approximation (VFA). Said value function approximation (VFA) is therefore initialized and updated by the processing unit by iterating over at least two scenarios of demands and vehicle allocations each over at least two periods of time and, for at least some, especially each, of said periods of time, based on data stored in the memory coupled with the processing unit. The processing unit calculates a set of vehicle locations or areas, especially a preferable set of vehicle locations or areas, by use of the current value function approximation (VFA) and updates the value function approximation (VFA) by using numerical derivatives of the current value function approximation (VFA) at the locations of the, especially preferable, set of vehicle locations or areas determined prior to the updating procedure. Following the calculations performed by the processing unit the results are communicated by the communication interface or communication engine.

In a further aspect, the present disclosure may provide a computer-readable memory comprising a memory of a hardware and software computer system; a set of computer-readable instructions stored by the memory which, when executed by a processor of the hardware and software computer system, causes the processor to calculate marginal values of vehicles at a geographic location and/or area, of an allocation of vehicles to demands and/or of relocation of vehicles to a geographic repositioning location or area by generating a value function approximation (VFA). Said value function approximation (VFA) is therefore initialized and updated by the processor based on data stored in the memory by calculating a, especially preferable, set of vehicle locations or areas by use of the current value function approximation (VFA) and updating the value function approximation (VFA) by using numerical derivatives of the current value function approximation (VFA) at the locations of the, especially preferable, set of vehicle locations or areas determined prior to the updating procedure. Following the calculations performed by the processor, the results may be stored in the memory. Thus, a database can be generated, which may help to improve said calculations.

In yet another aspect, the present disclosure may provide a method for calculating marginal values of vehicles at a geographic location and/or area, of an allocation of vehicles to demands and/or of relocation of vehicles to a geographic repositioning location or area within a hardware and software computer system, the method comprising generating a value function approximation (VFA). Said value function approximation (VFA) is therefore initialized and updated by calculating a, especially preferable, set of vehicle locations or areas by use of the current value function approximation (VFA) and updating the value function approximation (VFA) by using numerical derivatives of the current value function approximation (VFA) at the locations of the, especially preferable, set of vehicle locations or areas determined prior to the updating procedure. Calculated marginal values may be stored in a database within or communicated by the hardware and software computer system.

The system may additionally include a data gathering module or gathering engine to keep track of vehicle locations, e.g. a data interface to receive vehicle location updates. The system may additionally include a user demand gathering module or engine to enable user demand input, e.g. a data interface to receive user demands. This may be coupled to a smart phone application or a web application enabling the user to input the demands.

In another aspect the system may include a number of vehicles configured to provide their locations to the system, to the data gathering module, to the engine, or to the CPU.

In another aspect the system may include displays located in vehicles, especially front-window displays, to display messages from the communication engine.

In another aspect the system may use smart phones or tablets or third-party applications (apps) to display messages from the communication engine.

### BRIEF DESCRIPTION OF THE SEVERAL VIEWS OF THE DRAWINGS

FIG. 1 is a schematic representation of an embodiment of a hardware and software system suitable to execute the iterative method according to the invention.

FIG. 2 is a schematic representation of an embodiment of a hardware and software system suitable to execute the iterative method according to the invention.

FIG. 3 shows a flow chart of an iteration circle in an embodiment of an iterative method according to the invention.

FIG. 4 shows an exemplary updating procedure for a vehicle location yielding an optimized supply location.

### DESCRIPTION

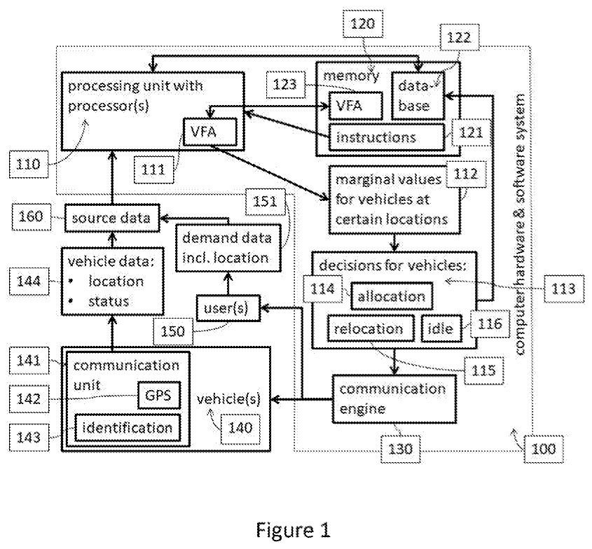

FIG. 1 shows a computer hardware and software system 100 comprising a processing unit 110 with one or more processors, a memory 120 and a communication engine 130 configured to use the iterative method and/or a model generated by said iterative method for positioning the vehicles for rent, for providing free-floating vehicles for rent, providing suitable positions for positioning or repositioning of vehicles for rent, and for forecasting vehicle demand. The vehicles in question may be automobiles or cars, or any other mode of transportation and are represented in FIG. 1 by the reference number 140.

As described above, the iterative method is used by the processing unit 110 to generate a model to calculate
at least one marginal value of a vehicle of a set of vehicles at a geographic location and/or an area within a given set of geographic locations or geographic areas and/or
at least one marginal value of an allocation of one of said vehicles of said set of vehicles to at least one demand of a set of vehicle demands and/or
at least one marginal value of relocation of a vehicle of said set of vehicles to a geographic repositioning location or geographic repositioning area within a given set of geographic locations or geographic areas
   by generating a value function approximation (VFA) with the processing unit 110. Said value function approximation (VFA) provides
at least one marginal value of a vehicle of said set of vehicles at a geographic location and/or
at least one marginal value of an allocation of one of said vehicles of said set of vehicles to at least one demand of a set of vehicle demands and/or
at least one marginal value of relocation of a vehicle of said set of vehicles to a geographic repositioning location or geographic repositioning area.

Therefore, said value function approximation (VFA) is
a) initialized and
b) updated by iterating over at least two scenarios of demands and vehicle allocations each over at least two periods of time and for at least some, especially each, of said periods of time,
   i. calculating a set of vehicle locations or areas, especially a preferable set of vehicle locations or areas, or a subset of said given set of vehicle locations or areas by use of the current value function approximation (VFA), and
   ii. updating the value function approximation (VFA) by using numerical derivatives of the current value function approximation (VFA) at the vehicle locations of or a subset of the vehicle locations of the, especially preferable, set of vehicle locations or areas determined in current step b.i.
      by the processing unit 110.

Thus, the processing unit 110 is suitable to perform a calculation based on a value function approximation (VFA) 111. The memory 120 contains instructions to use the VFA to calculate marginal values, locations and/or relocations of vehicles. The memory 120 may contain instructions 121 for performing the aforementioned iterative method and thus for generation or updating of such VFA 111 as well. When executed by the one or more processors of the processing unit 110 of the hardware and software system 100, instructions 121 cause the processing unit 110 to calculate marginal values of vehicles at a geographic location and/or area, of an allocation of vehicles to demands and/or of relocation of vehicles to a geographic repositioning location or area by generating a value function approximation (VFA) 111. Said value function approximation (VFA) 111 is therefore initialized and updated by the processing unit 110 based on data stored in the memory 120 by calculating a, especially preferable, set of vehicle locations or areas by use of the current value function approximation (VFA) 111 and updating the value function approximation (VFA) 111 by using numerical derivatives of the current value function approximation (VFA) 111 at the locations of the, especially preferable, set of vehicle locations or areas determined prior to the updating procedure. Furthermore, data can be stored in a database 122 inside the memory 120 and a VFA 123 can be stored in the database 122 or in the memory 120 as well. VFAs 111 and 123 may be different iterations of the same VFA based on the same data or VFA 123 can be a historic VFA stored for the purpose of quality improvement of future VFAs.

FIG. 1 also shows vehicle(s) 140 that include a communication unit 141 having a location tracking device like for example a Global Positioning System (GPS) device 142 and a device (not numbered) for providing an identification 143 of a vehicle, like a tag having saved an identification number on it. GPS data 142 and identification 143 together comprise vehicle data 144. Furthermore, user(s) 150 can demand vehicles, e.g. via a smart phone application or a website. The term “demand” therefore means that user(s) 150 is/are seeking for a vehicle for rent. This demand is used as demand data 151 including the location of a demand. Vehicle data 144 and demand data 151 together comprise the source data 160. The source data 160 is used by the processing unit 110 to calculate marginal values, locations and/or relocations based on the VFA 111. The source data 160 may additionally be used inside the processing unit 110 to update or generate the VFA. Beyond, this source data 160 can be stored in the database 122 as well because the processing unit 110 and memory 120 are operatively engaged with each other.

Based on the VFA 111, generated marginal values 112 may be calculated by the CPU 110 for certain vehicles 140 at certain geographical locations or areas. The geographical locations or areas may be or include the actual positions of the vehicles of a fleet of vehicles for rent, in particular within the operation rage of vehicle rental company or alike to whom the fleet of vehicles belong, e.g. inside a single city. Using said marginal values 112 decisions 113 can be made by the CPU 110 for each vehicle 140 e.g. based on the instructions 121. These decisions can be an allocation 114 of a vehicle 140 to a user's demand 151, relocation 115 of a vehicle 140 from one geographical location or area to a different geographical location or area or a decision to keep a vehicle idle 116 at a certain geographical location or area. Information regarding said decision can be stored inside the memory's database 122 for the purpose of enabling the system 100 to learn from previous iterations and/or VFAs in order to optimize future iterations and/or VFAs.

Furthermore decisions 113 can be communicated to vehicles 140 and/or users 150 via the communication engine 130. While all decisions may be communicated to vehicles 140, decisions communicated to users 150 may be limited to allocation decisions 114. Relocations decisions may be further communicated to personnel handling the relocations, e.g. by driving or transporting the vehicle to the repositioning position, i.e., to a different geographical location.

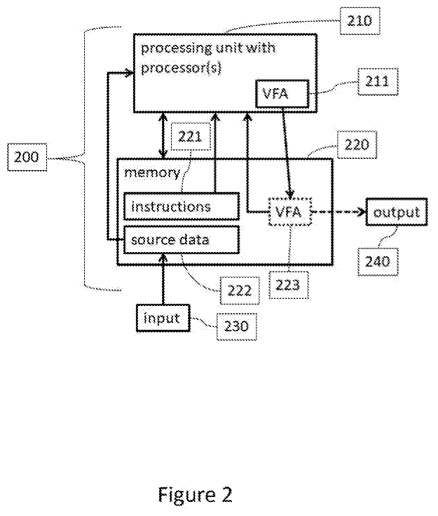

FIG. 2 shows a second embodiment but it may be as well incorporated in the embodiment of FIG. 1. It shows a computer hardware and software system 200 comprising a processing unit 210 with one or more processors as well as a memory 220. Processing unit 210 and memory 220 are coupled with each other. The computer hardware and software system 200 is built to execute an iterative method according to the invention and therefore includes computer-readable instructions 211 in the processing unit 210 or, as shown in FIG. 2, in the memory 220 to be loaded into the processing unit 210 for doing so such that when executed by the processing unit 210 of the hardware and software system 200, instructions 221 cause the processing unit 210 to calculate marginal values of vehicles at a geographic location and/or area, of an allocation of vehicles to demands and/or of relocation of vehicles to a geographic repositioning location or area by generating a value function approximation (VFA) 211. Said value function approximation (VFA) 211 is therefore initialized and updated by the processing unit 210 based on data stored in the memory 220 by calculating a, especially preferable, set of vehicle locations or areas by use of the current value function approximation (VFA) 211 and updating the value function approximation (VFA) 211 by using numerical derivatives of the current value function approximation (VFA) 211 at the locations of the, especially preferable, set of vehicle locations or areas determined prior to the updating procedure. Following the calculations performed by processing unit 210, the results may be stored in the memory 220, in particular the generated/updated VFA may be stored as VFA 223. The processing unit 210 is capable of generating and/or updating a value function approximation (VFA) 211. Necessary instructions 221 and source data 222 generated by an input 230 may be loaded from the memory 220 and into the processing unit 210. CPU 210 may, by use of the instructions and the source data 222, calculate/update a VFA 211. Following execution of the instructions 221, the generated/updated VFA 211 can be stored in the memory 220 as a VFA 223. Said VFA 223 can be reloaded into the processing unit 210 for a multitude of iterations so that the VFA 211 can be optimized according to the instructions 221 Furthermore VFAs 211 and 223 may be VFAs for different scenarios or at different periods in time or for different iteration steps. Thus stored, historic VFAs can be used for the purpose of learning inside the computer system 200. VFAs, especially updated VFAs, or the results thereof can be used as an output 240 as well, especially for example for positioning vehicles for rent, for providing free-floating vehicles for rent, for providing suitable positions for positioning or repositioning of vehicles for rent, for forecasting vehicle demand and/or for providing a model to forecast vehicle demand and/or calculate suitable positions for positioning or repositioning of vehicles for rent. Those vehicles may be vehicles as described as vehicle(s) 140 in FIG. 1.

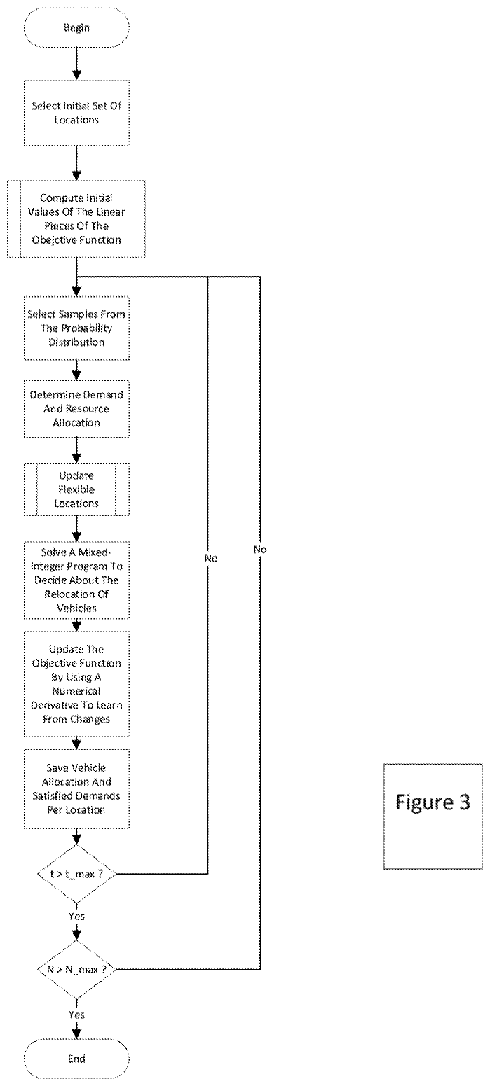

FIG. 3 shows a flow chart of an iteration circle in an embodiment of an iterative method according to the invention. In a first step of the iterative method, an initial set of geographical locations is selected, in particular based on the actual positions of vehicles and/or the actual positions of users demanding a vehicle and/or actual positions with a demand for a vehicle in the real world or on the earth. In a second step of the method according to the invention, the initial values of linear pieces of the objective function are computed by the CPU. In a third step of the method according to the invention, samples of the probability distribution or a scenario are selected by the CPU, especially data, all or at least some, of the given period in the given scenario. In a fourth step of the method according to the invention, demand and resource allocation is determined. In a fifth step of the method according to the invention, the flexible locations are updated based on the computed values. In a sixth step of the method according to the invention, a Mixed-Integer Program is solved to calculate optimized vehicle positions. In a seventh step of the method according to the invention, the objective function (VFA) is updated by using at least a numerical derivate to adapt to the executed changes. Vehicle allocation and satisfied demands for locations are saved. This procedure is executed repetitively over a multitude of iteration circles until a defined number of periods of time (t_max) and a defined number of scenarios (N_max) is reached.

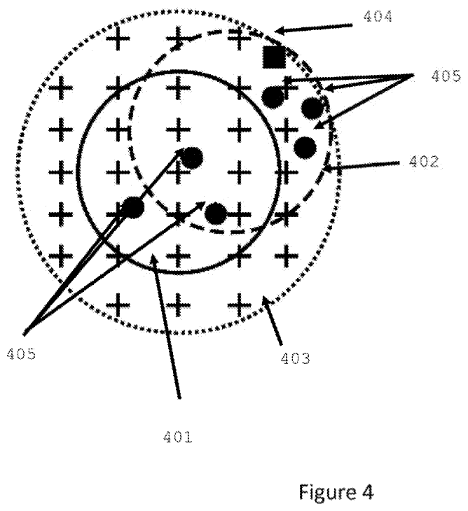

FIG. 4 depicts the updating procedure performed by system 100 or system 200 regarding geographical location or area optimization in an iterative method according to the invention by maximization of unallocated vehicles inside a supply-location or supply-area. The initial/current location or area is represented by the solid circle 401. Dots 405 show positions of unallocated vehicles whereas squares 404 represent ((yet) unsatisfied) demands. The updating procedure aims to find locations or areas with a maximum of either unallocated vehicle (supply locations) or (yet unsatisfied) demands (demand locations). Therefore, possible new locations or areas (locations or centers of areas depicted by plusses) are checked within a predefined area (dotted circle 403) around the initial location or area. As shown in FIG. 4, an optimized supply-location can be found by moving the area 401 to find the area represented by the dashed circle 402 or the location as center of the dashed circle 402. While the dotted circle 403 represents the limit of moving the area. The number of unallocated vehicles is increased from three to five as well as the number of (unsatisfied) demands being increased from zero to one. Hence a net profit of one additional unallocated vehicle after allocation of one of the previously unallocated vehicles to the previously unsatisfied demand is achieved in the shifted and optimized location or area.

Features and advantages shown in the figures are not limited to single embodiments and may be combined by a person ordinary skilled in the art.

Hereafter, an exemplary pseudo-algorithm is presented using the invented method.

Algorithm 1:

| | |
|---|---|
| 1: | function FADP_PWL(Ω) |
| 2: | Lₜ^{S}, Lₜ^{D} ← INITIALIZE_SUPPLY_DEMAND(t) |
| 3: | V̅ᵢₜ⁰ ← INITIALIZE_PWF(i, t) ∀ i ϵ L^{S} ∪ L^{D}, t ϵ T |
| 4: | Initialize uf₀⁰, ff₀⁰, uv₀⁰ to empty sets |
| 5: | while n ≤ N do |
| 6: | ωⁿ ← RANDOM_SAMPLE(Ω) |
| 7: | for ∀t ϵ T do |
| 8: | \hat{D}ₜ ← DETERMINE_DEMAND(ωⁿ) |
| 9: | Rₜ, \hat{R}ₜ ← DETERMINE_RESOURCES(ωⁿ) |
| 10: | xₜ(ω\dot{ⁿ}), yₜ(ωⁿ) ← SOLVE_AGGREGATED_MODEL(Vₜ(Rₜ)) |
| 11: | Carry out repositionings determined by the aggregated |
| | model |
| 12: | Realize scenario ωⁿ: Update vehicle locations |
| 13: | ufₜⁿ ← UNFULFILLED_DEMAND(ωⁿ) |
| 14: | ffₜⁿ ← FULFULFILLED_DEMAND(ωⁿ) |
| 15: | uvₜⁿ ← UNUSED_VEHICLES(ωⁿ) |
| 16: | \hat{v}ₜⁿ(ωⁿ) ← NUMERICAL_DERIVATIVE(V̅ᵢₜⁿ(Rₜ) |
| 17: | V̅ᵢₜⁿ⁺¹(Rₜ) ← UPDATE_VFA(V̅ᵢₜⁿ(Rₜ) |
| 18: | UPDATE_LOCATION_POSITIONS(Lₜ^{S}, Lₜ^{P}, ufₜ₊₁ⁿ⁻¹, |
| | ffₜ₊₁ⁿ⁻¹, uvₜⁿ⁻¹) |
| 19: | return V̅ᵢₜ, xₜ, yₜ ∀i ϵ L, t ϵ T |

Algorithm 1 shows an Approximate Dynamic Programming (ADP) using a piece-wise linear Value Function Approximation (VFA) according to the iterative method as presented above. In Particular, Algorithm 1 describes the generation of the VFA which can be divided into an initialization procedure (lines 2 to 4 in Algorithm 1; see step a) in the presented iterative method) as well as an updating procedure (lines 5 to 18 in Algorithm 1; see step b) in the presented iterative method), further defined by the following pseudo codes.

Regarding Algorithm 1, first of all in line 2, the supply (vehicle surplus) and the demand (vehicle deficit) locations are chosen at a certain time t. In this regard, the following Algorithm 2 is used.

Algorithm 2:

| | |
|---|---|
| 1: | function INITIALIZE_SUPPLY_DEMAND(t) |
| 2: | Let G be the set of candidate locations for period t |
| 3: | S ← ∪_{iϵG} {score(i, walk-dist, t)} |
| 4: | μ ← mean(S) |
| 5: | σ ← stdev(S) |
| 6: | Lₜ^{S} ← all candidate locations with a score larger than μ + p⁺ σ |
| 7: | Lₜ^{D} ← _ all candidate locations with a score smaller than |
| | μ − p⁻ σ |
| 8: | return Lₜ^{S}, Lₜ^{D} |

Algorithm 2 selects and initializes the supply and demand locations to be used in the generation of the VFA. Therefore, a set of candidate locations G is used for the period t. Next, at set of segments S is chosen for the piece-wise value function based on the heuristic score of a location. The heuristic score can be determined based on the general equation

score(l,r,t):=R′ₜₗ−θₜₗ+ηₜₗ,

where θₜₗ represents the number of trips starting from a location l in a period t. ηₜₗ gives the number of trips ending in location l in a period t and R′ₜₗ is the number of vehicles in location l at the beginning of period t. In the presented example, r is given by the walk-dist, which is the distance a customer is willing to walk for a vehicle, generally around 500 meters. Mean values and standard deviations are calculated separately for supply and demand locations. Afterwards, all locations with a score exceeding μ+p⁺σ are selected to be supply locations Lₜ^{S} whereas locations with a score falling below μ−p⁻σ are selected as demand locations Lₜ^{D}, with p being the number of standard deviations. Algorithm 2 returns the sets Lₜ^{S} and Lₜ^{D} for further usage in Algorithm 1 (see line 8 in Algorithm 2 and line 2 in Algorithm 1).

Next in line 3 of Algorithm 1, the piece-wise function is initialized for all locations i of the sets Lₜ^{S} and Lₜ^{D} (which were determined in line 2 of Algorithm 1 respectively in Algorithm 2) for a period t being element of a set of periods T giving the initial values Vᵢₜ⁰ at a location i at a certain period t. In this regard, Algorithm 3 is used.

Algorithm 3:

| | |
|---|---|
| 1: | function INITIALIZE_PWF(i,t) |
| 2: | r ← Set of all revenues of trips starting in period t within w meters of location i |
| 3: | s ← ┌min{p^{pwf}_max, mean(r) + p^{σ}stdev(r)}┐ [symbol] Number of PWF segments |
| 4: | if thens ≥ max{r} [symbol] Adjustment for non-Gaussian locations |
| 5: | s ← └mean(r)┘ |
| 6: | Sort r descending |
| 7: | cs ← cumulative sum of r at each index of r |
| 8: | return First s elements of cs |

Algorithm 3 starts by determining a set r of all revenues gained by starting trips, thus fulfilled demands, within a distance of w meters of locations i in period t.

Lines 3 to 5 calculate the number of pieces of the VFA to be constructed.

The revenues r are sorted descending by their value. Afterwards a cumulative sum cs for each revenue r is built for each index i of each revenue r. Finally, Algorithm 3 returns the first s elements of the cumulative sum cs for further usage in Algorithm 1. Additionally, it shall be noted, that the initialization can be vectorized and/or aggregated over all locations and time periods into a single step without change to the functionality.

At next in line 4 of Algorithm 1, initial values of vehicle request (uf₀⁰), fulfilled vehicle requests (ff₀⁰) and unused vehicles (uv₀⁰) at time 0 in iteration 0 are initialized before the iteration procedure (lines 5 to 18 in Algorithm 1) starts. For n≤N iteration is performed for all scenarios ωⁿ for all periods t of a set of periods T.

Within every iteration step, at first, the demands \hat{D}ₜ are determined within scenario ωⁿ in line 8, followed by determining the resources Rₜ and \hat{R}ₜ within scenario ωⁿ in line 9. Rₜ represents the number of vehicles available while \hat{R}ₜ contains the exogenous change of vehicles at all locations i at a certain period t.

At next in line 10, the aggregated model (as described above by formulas 0-6) is solved resulting in reposition decisions xₜ(ωⁿ) and an amount of satisfied demands yₜ(ωⁿ) in a certain scenario ωⁿ. Subsequently, the repositionings determined by the aggregated model are carried out virtually within the model meaning that while iterating, the reposition decisions are not used to reposition a vehicle in the real world, and the vehicle positions are updated virtually so that scenario ωⁿ is virtually realized within the iteration step (see lines 11 and 12). Consequently, values for unfulfilled demands (ufₜⁿ), fulfilled demands (ffₜⁿ) and unused vehicles (uvₜⁿ) can be determined at a time period t for scenario ωⁿ within iteration step n (lines 13 to 15).

Additionally, marginal values of the value function V̅ᵢₜⁿ are determined in line 16 by

\hat{v}ᵢₜⁿ⁺(ωⁿ)=V̅ᵢₜⁿ(Rᵢₜⁿ+1|ωⁿ)−V̅ᵢₜⁿ(Rᵢₜⁿ|ωⁿ),

\hat{v}ᵢₜⁿ⁻(ωⁿ)=V̅ᵢₜⁿ(Rᵢₜⁿ|ωⁿ)−V̅ᵢₜⁿ(Rᵢₜⁿ−1|ωⁿ), (7)

where \hat{v}ᵢₜⁿ⁻(ωⁿ) is the left and \hat{v}ᵢₜⁿ⁺(ωⁿ) the right numerical derivatives within the evaluated scenario ωⁿ in iteration step n. Since Rᵢₜⁿ contains the number of vehicles at location i in period t, Rᵢₜ+1 respectively Rᵢₜ−1 corresponds to an increase (for +1) respectively a decrease (for −1) of the number of vehicles by a single vehicle at the respective location i in period t.

Subsequently, these marginal values \hat{v}ᵢₜⁿ⁻(ωⁿ) and \hat{v}ᵢₜⁿ⁺(ωⁿ) are used in the updating procedure of the VFA V̅ᵢₜⁿ⁺¹ for the subsequent iteration n+1 as shown in line 17 by performing

$${\overline{V}}_{i t}^{n + 1} ( {R}_{i t} ) = ( \begin{matrix}{\overline{V}}_{i t}^{n} ( {R}_{i t} ) + α ( {\hat{v}}_{it}^{n +} ( {ω}^{n} ) - {\overline{v}}^{n +} ( {R}^{n} ) ) {R}_{it} , if {R}_{it} \geq {R}_{it}^{n} , \\ {\overline{V}}_{i t}^{n} ( {R}_{i t} ) + α ( {\hat{v}}_{it}^{n -} ( {ω}^{n} ) - {\overline{v}}^{n -} ( {R}^{n} ) ) {R}_{it} , if {R}_{it} \leq {R}_{it}^{n}\end{matrix} , \qquad ( 8 )$$

where α is a learning rate within 0≤a≤1, which defines to which degree the current iteration changes the VFA. Additionally, \hat{v}ⁿ⁺(Rⁿ) and \hat{v}ⁿ⁻(Rⁿ) are numerical derivates of the previous estimated VFA V̅ᵢₜⁿ(Rᵢₜ). Since the added term in the VFA updating procedure are a concave approximation as well as a linear correction, the concavity of the VFA is maintained throughout the updating procedure.

Finally, the location positions (see line 18 in Algorithm 1) are updated prior to the next iteration n+1 step using Algorithm 4.

Algorithm 4:

| | |
|---|---|
| 1: | function UPDATE_LOCATION_POSITIONS(Lₜ^{S}, Lₜ^{P}, ufₜ₊₁ⁿ⁻¹, |
| | ffₜ₊₁ⁿ⁻¹, uvₜⁿ⁻¹) |
| 2: | for i ϵ Lₜ^{S} do |
| 3: | Let Gᵢ be a grid of potential new centers for i |
| 4: | cands ← arg max_{gϵG}_{ᵢ} {uvₜⁿ⁻¹} |
| 5: | Replace i in Lₜ^{S} with arg min_{gϵcands}{ufₜ₊₁ⁿ⁺¹}, breaking ties at |
| | random |
| 6: | for i ϵ Lₜ^{D} do |
| 7: | Let Gᵢ be a grid of potential new centers for i |
| 8: | Replace i in Lₜ^{D} with arg max_{gϵG}_{ᵢ} {ufₜ₊₁ⁿ⁻¹ + ffₜ₊₁ⁿ⁻¹} |
| | breaking ties at random |

Therefore, the locations are adapted to the results of iteration step n as determined in prior steps of Algorithm 1 (see lines 1 to 17). Updating the locations i in supply locations Lₜ^{S} is by evaluating new possible centers for locations i from a grid Gᵢ. The candidates cards are chosen by arguments of the maxima function (arg max) regarding the number of unused vehicles (uvₜⁿ⁻¹) within the previous iteration n−1 at locations i. Afterwards, the most suitable locations within candidates cards are selected by arguments of the minima function (arg min) regarding a forecast for unfulfilled demands (ufₜ₊₁ⁿ⁺¹) in the subsequent iteration n+1 as the new locations i for the subsequent iteration step n+1 by replacing the former locations. If locations are tied, ties are broken at random.

Additionally, new locations i for demand locations Lₜ^{D} are selected. Therefore, potential new centers for locations i are selected for replacing the former centers by using an arg max function regarding the sum of unfulfilled (ufₜ₊₁ⁿ⁻¹) and fulfilled demands (ffₜ₊₁ⁿ⁻¹) within the previous iteration n−1. If locations are tied, ties are broken at random, too.

The location updating procedure is additionally described above in FIG. 3.

Finally, especially after a maximum of N iterations, Algorithm 1 returns the value function V̅ᵢₜ as well as repositioning decisions xₜ and satisfied demands yₜ for each location i as well as periods t (see line 19 of Algorithm 1), in particular to be used to position and/or reposition vehicles at corresponding geographical locations and/or areas in the real world.

TABLE 1
Notation

| Sets | |
|---|---|
| Ω | Set of scenarios |
| T | Set of time periods |
| Lₜ^{S},Lₜ^{D} | Set of supply and demand locations, respectively, |
| | at time t ∈ T |
| N | Set of iterations |
| G | Set of candidate locations |
| D | Set of demands |
| Dᵢₜ | Set of demands at location i at time t, Dᵢₜ ⊆ D, |
| | Dₜ = (Dᵢₜ)_{i∈L} |
| [symbol] | Set of vehicles |
| S | Set of segments for the piecewise value function |
| Parameters | |
| n | Iterations n ∈ N |
| α | Learning rate (stepsize) used for an update of an |
| | objective function |
| γ | Discount rate for future periods |
| t | Discrete time periods t ∈ T |
| ω | Scenario ω ∈ Ω |
| ωⁿ | Scenario in iteration n |
| cᵢⱼₜ^{r} | Cost of repositioning a vehicle from location i to |
| | j at time t |
| r_{dt} | Revenue for fulfilling a unit of demand d ∈ [symbol] ₜ |
| | at time t, Dₜ ⊆ D |
| s | Number of PWF segments |
| Rᵢₜ | Number of vehicles available at location i at time t, |
| | Rₜ = (Rᵢₜ)_{i∈L} |
| \hat{R}ᵢₜ | Exogenous change of vehicles at location i at time |
| | t, \hat{R}t = (\hat{R}ᵢₜ)_{i∈L} |
| \hat{D}ᵢₜ | Exogenous change in demand at location i and at |
| | time t, \hat{D}ₜ = (\hat{D}ᵢₜ)_{i∈L} |
| Cₜ | One period contribution function |
| V̅ᵢₜ⁰ | Initial value at location i and at time t |
| V̅ᵢₜⁿ | Value in iteration n at location i and at time t |
| V̅ᵢₜ (Rᵢₜ) | Value associated with Rᵢₜ vehicles at location i and |
| | at time t |
| \hat{v}ᵢₜ | Marginal value of a vehicle at location i and at time t |
| \hat{v}ₜⁿ (ωⁿ) | Marginal value of vehicles in iteration n at time t |
| | based on scenario ωⁿ in iteration n |
| \hat{v}ᵢₜⁿ⁺ (ωⁿ), | Left and right numerical derivatives at time t based |
| \hat{v}ᵢₜⁿ⁻ (ωⁿ) | on scenario ωⁿ in iteration n |
| v̅ⁿ (Rⁿ), v̅ⁿ⁻ | Left and right numerical derivatives of the previous |
| | estimate of the value function |
| Wₜ | New random information arriving at period t, |
| | Wₜ = (\hat{R}ₜ, \hat{D}ₜ) |
| μ | Mean |
| σ | Standard deviation |
| cs | Cumulative sum |
| p^{σ} | Number of standard deviations of the journey revenues |
| | to use when initializing the piecewise function |
| Variables | |
| xᵢⱼ ∈ [symbol] | The number of vehicles to reposition from location i |
| | to location j. |
| xₜ (ωⁿ) | Repositioning decisions in period t based on scenario |
| | ωⁿ in iteration n. |
| yₜ (ωⁿ) | Amount of satisfied demand in period t based on |
| | scenario ωⁿ in iteration n. |
| yᵢ^{D} (ω) ∈ [symbol] | Amount of demand satisfied in location i in scenario |
| | ω that is not over in the current period. |
| yᵢⱼ^{S} (ω) ∈ [symbol] | Amount of demand satisfied in location i in scenario |
| | ω within the current period. |
| zᵢ (ω) | The “value” of having vehicles at location i at the end |
| | of the current period, as represented by a piecewise |
| | function. |
| wᵢ (ω) | The revenue earned per vehicle at location i. |
| ufₜⁿ, ffₜⁿ, uv | Unfulfilled vehicle requests, fulfilled vehicle requests, |
| | and unused vehicles at time t in iteration n. |
| uf₀⁰, ff₀⁰, uv | Initial values of vehicle requests, fulfilled vehicle |
| | requests, and unused vehicles at time 0 in iteration 0. |

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Additionally, any method of performing the present disclosure may occur in a sequence different than those described herein. Accordingly, no sequence of the method should be read as a limitation unless explicitly stated. It is recognizable that performing some of the steps of the method in a different order might achieve a similar result.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used, Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to.

In the foregoing description, certain terms have been used for brevity, clarity, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A software stored on a computer-readable memory; said software comprising:
computer-readable instructions such that when loaded into a memory of a computer system and executed by one or more processors of said computer system:
perform, with said one or more processors, an iterative method to generate a model regarding allocation or repositioning of at least one vehicle of a set of vehicles;
calculate, with said one or more processors:
at least one marginal value of an allocation of the at least one vehicle of the set of vehicles to at least one demand of a set of vehicle demands; or
at least one marginal value of a relocation of the at least one vehicle of the set of vehicles to a geographical repositioning location or a geographical repositioning area within a given set of geographical locations or geographical areas;
by generating a value function approximation (VFA);
said VFA providing for a vehicle sharing system or ride sharing system with said set of vehicles;
at least one marginal value of the at least one vehicle of said set of vehicles at a geographical location or a geographical area; or
at least one marginal value of an allocation of the at least one vehicle of said set of vehicles to at least one demand of a set of vehicle demands; or
at least one marginal value of a relocation of at least one vehicle of said set of vehicles to said geographical repositioning location or said geographical repositioning area;
by performing the following steps with said one or more processors:
a. initializing said VFA; and
b. iteratively updating the VFA by iterating over at least two scenarios of demands and vehicle allocations each over at least two periods of time and for at least some of said at least two periods of time;
i. calculating a set of vehicle locations or areas from said given set of geographical locations or geographical areas or from a subset of said given set of geographical locations or geographical areas by use of the VFA of a current iteration step, and
ii. updating the VFA prior to a following iteration step by using numerical derivatives of the VFA of the current iteration step at the geographical locations or geographical areas or a subset of locations of the set of vehicle locations or areas determined in step b.i. of the current iteration step; and
deriving from said generated model with one or more processors an allocation or repositioning decision regarding the at least one vehicle of said set of vehicles and outputting such decision via a display or to an electronic interface.

2. The software according to claim 1, wherein the electronic interface is an interface of a control unit of the at least one vehicle of said set of vehicles or of a communication device.

3. The software according to claim 1, wherein the updating in step b.ii. includes or is performed by adding a term including a numerical right derivative or left derivative of the VFA of the current iteration step and a term including a numerical right derivative or left derivative of the VFA of a previous iteration step.

4. The software according to claim 3, wherein the updating in step b.ii. includes or is performed by adding a term including a difference between the numerical right derivative or left derivative to the VFA of the current iteration step and the numerical right derivative or left derivative to the VFA of the previous iteration step, multiplied by a learning rate factor.

5. The software according to claim 1, wherein the VFA is piecewise linear.

6. The software according to claim 5, wherein a number of pieces in said piecewise-linear VFA equals a number of vehicles that on average generate marginal value and/or wherein the values of the number of pieces in said piecewise-linear VFA represent the marginal value of a respective number of vehicles in the geographical location or geographical area which is a scenario-dependent value and/or time-dependent value that is iteratively updated.

7. The software according to claim 6, wherein initialization in step a. includes calculating the number of vehicles that on average generate additional value in a first number of scenarios of demands and using said piecewise-linear VFA with as many of the number of pieces as the number of vehicles that on average generate additional value in the first number of scenarios of demands and initializing the VFA in a way that the values of the number of pieces represent an average marginal value of a respective number of vehicles in the geographical location or geographical area.

8. The software according to claim 1, further comprising calculating the set of vehicle locations in step b.ii. by solving a Mixed-Integer Program with said one or more processors or choosing the set of vehicle locations such that the set of vehicle locations is a near optimal set of vehicle locations regarding the marginal value.

9. The software according to claim 1, wherein different subsets of said set of vehicles are used in different iterations optimizing the selected geographical locations or geographical areas during iteration through the at least two periods of time and/or at least two scenarios of demands.

10. The software according to claim 5, wherein prior to initializing said VFA in step a. an initial set of geographical locations or geographical areas is selected from said given set of geographical locations or geographical areas by:
computing with said one or more processors, a heuristic score that indicates whether demand at one geographical location or geographical area of said given set of geographical locations or geographical areas deceeds or exceeds a number of vehicles located at said one geographical location or geographical area or located within a predefined radius around said one geographical location or geographical area; and
choosing as a first initial set all or a subset of the geographical locations or geographical areas that exceed or deceed a mean demand by a predefined threshold; and
wherein for each of the geographical locations or geographical areas a piece of said piecewise-linear VFA is calculated with said one or more processors to initialize said VFA.

11. The software according to claim 1, wherein in at least every 5th iteration step prior to next step b.i. or at least once within or after iterating through the at least two periods of time of the scenario of the current iteration step prior to next step b.i., a subset of geographical locations or geographical areas of said given set of geographical locations or geographical areas is chosen by:
i. evaluating a set of potential new geographical locations or geographical areas of said given set of geographical locations or geographical areas, said set of potential new geographical locations or geographical areas being those within a predefined distance to the locations of the set of vehicle locations or areas,
ii. after applying the current VFA updated during the previous iteration step to the demands of the period of time of the current iteration step, choosing the subset geographical locations or geographical areas by selecting from said set of potential new geographical locations or geographical areas those with maximal demand, including both fulfilled demands and unfulfilled demands, for vehicles and/or those with maximal unallocated vehicles in the previous period, wherein if at least two geographical locations or geographical areas of said set of potential new geographical locations or geographical areas show a same amount of demand of the geographical location(s) or geographical area(s) with a lowest amount of unallocated vehicles of said at least two geographical locations or geographical areas with the same amount of demand is/are selected for said chosen subset of geographical locations or geographical areas.

12. The software according to claim 1, wherein all geographical locations or geographical areas are of identical size and/or identical shape.

13. The software according to claim 1, wherein the VFA is a concave piecewise-linear separable VFA and/or wherein the VFA is a piecewise-linear separable VFA with fixed integer breakpoints.

14. The software according to claim 1, wherein the VFA is an adapted Bellman function comprising both a contribution function containing vehicle demands and repositioning of vehicles at a current period of time and an approximated value function for a subsequent period of time.

15. The software according to claim 1, wherein updating in step b.ii. takes into account one or more of the following constraints:
a. flow conservation due to every vehicle being repositioned, assigned to a demand or left idle at a current period of time;
b. keeping track of vehicle movements enabling decisions at a subsequent period of time considering the repositioning decisions and the destinations of satisfied demands at the current period of time; and
c. ensuring that a single demand is assigned only once.

16. A hardware and software system comprising a computer system with one or more processors, a memory and computer-readable instructions stored in said one or more processors or said memory;
said computer-readable instructions configured to:
giving an iterative method to generate a model regarding allocation or repositioning of at least one vehicle of a set of vehicles when executed by said one or more processors; and
calculating with said one or more processors:
at least one marginal value of an allocation of the at least one vehicle of said set of vehicles to at least one demand of a set of vehicle demands; or
at least one marginal value of relocation of the at least one vehicle of said set of vehicles to a geographical repositioning location or geographical repositioning area within a given set of geographical locations or geographical areas;
by generating a value function approximation (VFA), said VFA providing for a vehicle sharing system or ride sharing system with said set of vehicles;
at least one marginal value of the at least one vehicle of said set of vehicles at the geographical location or geographical area; or
at least one marginal value of an allocation of the at least one vehicle of said set of vehicles to at least one demand of the set of vehicle demands; or
at least one marginal value of relocation of the at least one vehicle of said set of vehicles to said geographical repositioning location or geographical repositioning area;
by performing the following steps with said one or more processors:
a. initializing said VFA and
b. iteratively updating the VFA by iterating over at least two scenarios of demands and vehicle allocations each over at least two periods of time and for at least some of said at least two periods of time;
i. calculating a set of vehicle locations or areas from said given set of geographical locations or geographical areas or a subset of said given set of geographical locations or geographical areas by use of a current value function approximation (VFA), and
ii. updating the VFA by using numerical derivatives of the current VFA at the locations of or the subset of the locations of the set of vehicle locations or areas determined in current step b.i.; and
deriving from said generated model with one or more processors, an allocation or repositioning decision regarding the at least one vehicle of said set of vehicles and outputting such decision via a display or to an electronic interface.

17. The system comprising a set of vehicles and a computer system with one or more processors, a memory and a software according to claim 1 stored in said computer system; such that when said software is executed by said one or more processors, a model is generated by performing the iterative method of said software by said one or more processors for providing suitable positions for positioning or repositioning of at least one vehicle of said set of vehicles to the geographical location or geographical area using the derived allocation or repositioning decisions from said model generated by said one or more processors.

18. The system according to claim 16, wherein said at least one derived allocation or repositioning decision is communicated to a control unit of the at least one vehicle of said set of vehicles such that said at least one vehicle automatically repositions itself or is allocated to a demand.

19. The system according to claim 16, wherein at least one derived allocation or repositioning decision is communicated to a person over a display or communication unit;
giving said person a command to reposition the at least one vehicle of said set of vehicles to the geographical location or geographical area; or
giving information that a vehicle has been allocated to a demand.

20. The system according to claim 16 for managing a vehicle fleet, the set of vehicles being a vehicle fleet comprised of a multitude of vehicles, wherein said vehicle fleet is managed regarding positioning vehicles of the vehicle fleet for rent at said geographical locations or geographical areas.
